(19) United States
(12) Patent Application Publication
(10) Pub. No.: US 2005/0210147 A1
(43) Pub. Date: Sep. 22, 2005

(54) Packet-oriented data transmission system with a selectable operating mode for the particular data transmission connection

(75) Inventors: Stephanie Genety, Munchen (DE); Christoph Hielscher, Munchen (DE); Stefan Jenzowsky, Munchen (DE); Hubert Jager, Pullach (DE)

Correspondence Address: SIEMENS CORPORATION;INTELLECTUAL PROPERTY DEPARTMENT, 170 WOOD AVENUE, SOUTH, ISELIN, NJ, 08830, US

(73) Assignee: SIEMENS AKTIENGESELLSCHAFT

(21) Appl. No.: 11/081,444

(22) Filed: Mar. 16, 2005

(30) Foreign Application Priority Data
Mar. 16, 2004 (DE) 10 2004 012 892.8

(51) Int. Cl. G06F 15/173

(52) U.S. Cl. 709/243

(57) ABSTRACT

Packet-oriented data transmission system with a selectable operating mode for the particular data transmission connection In a packet-oriented data transmission system (PDS) consisting of a data transmission network (DN) and several decentralized data transmission devices (DE1 to DEn) connected to the data transmission network (DN), with data packets (DP) of at least one data transmission connection (dv1) being transmitted between one or more decentralized data transmission devices (DE1 to DEn) and the data transmission network (DN), and a packet labeling unit (PLE) is provided in at least one of the decentralized data transmission devices (DE1) for marking the data packets (DP) of a data transmission connection (dv1). In addition, at least one packet inspection unit (PIE) is provided in the data transmission network (DN), for the acquisition of the marking applied to the data packets (DP) of a data transmission connection (dv1), with the operating mode of the data transmission connection (dv1) existing between the at least one decentralized data transmission device (DE1) and the data transmission network (DN) being selected depending on the marking determined by the packet inspection unit (PIE).

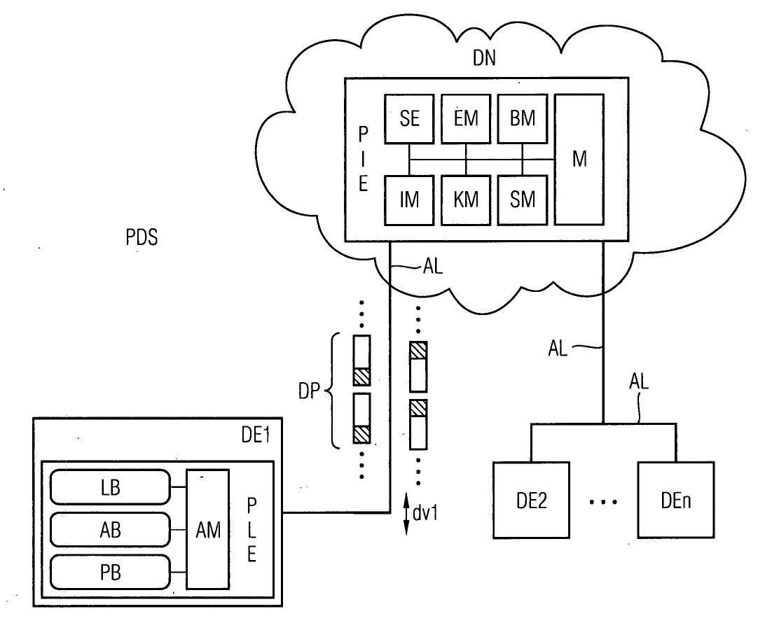

### CROSS REFERENCE TO RELATED APPLICATIONS

This application claims priority to the German application No. 10 2004 012 892.8, filed Mar. 16, 2004 and which is incorporated by reference herein in its entirety.

### FIELD OF INVENTION

The invention relates to a packet-oriented data transmission system consisting of a data transmission network and several decentralized data transmission devices connected to the data transmission network, with data packets of at least one data transmission connection being transmitted between one or more decentralized data transmission devices and the data transmission network.

### BACKGROUND OF INVENTION

In the data transmission systems realized at present, it has already been attempted to link the “browsing behavior” of network customers on the Internet with potential useful additional information, in order, by networking the Internet pages called up by the network customers and the Internet services used as well as all potential useable information sources, to generate a service offering tailored to the particular network customer by linking and correlating this information. In this way, an attempt is made to offer the particular network customer value added services specially tailored to his “browsing behavior”, i.e. access behavior on the Internet, such as a suitable collection of links or the current share prices of share values frequently requested in the past by the network customer or other offers tailored to the area of interest of the network customer.

Such methods are at present realized by using servers or server groups assigned to the data transmission network, that receive more specific information on the utilization and access behavior of a network customer by means of “cookies” assigned to the network customer. However, the disadvantage is that such server-based solutions are limited to a single server or server group, so that information regarding the “browsing behavior” of this network customer can be determined only at the time at which a network customer uses a server or server group. A user-specific configuration of the user interface and of the contents of Internet portals can of course facilitate such a utilization of certain servers or server groups by the network customers, but the main disadvantage is still that not all potentially usable correlations between the theoretically existing information can be established because of the ease with which such servers or server groups can be bypassed. The information content of such value added services, for example offered in an Internet portal, is thus of only limited use for the particular network customer. Particularly with confidential data transmission applications such as “home banking”, such “monitoring” of a data transmission connection via a server of this kind at the network customer's end is undesirable. In this case, access by the network customer to the data transmission network can also take place by a mobile data transmission device via an air interface.

Furthermore, a technology for the categorization and differentiation between different Internet services is known, for example from WO 2002096043 A1, under the designation “deep packet inspection”, with the aid of which headers of the data packets (TCP=Transmission Control Protocol; IP=Internet Protocol; etc.) transmitted via different data transmission protocols can be identified at “wire speed”, including on a multi-layer basis (layers 1 to 3 of the OSI=Open System Interconnection layer model). In this case, the “deep packet inspection” technology is used as a type of filter to enable a distinction to be made between different data transmission services provided by a service provider in a data transmission system, for example where there are various different access volumes. The disadvantage of this technology is that only the headers of the data packets and not the contents of the data packets of at least a specified number of transmitted data packets are analyzed.

### SUMMARY OF INVENTION

The object of the invention is therefore to make the design of a packet-oriented data transmission system more flexible with regard to the choice of different operating parameters for individual data transmission connections. The object is achieved by the claims.

The essential aspect of the packet-oriented data transmission system in accordance with the invention is that a packet labeling unit for marking data packets of a data transmission connection is provided in at least one of the decentralized data transmission devices. Furthermore, at least one packet inspection unit is provided in the data transmission network for the acquisition of the marking applied to the data packets of a data transmission connection, whereby the operating mode of the data transmission connection existing between the at least one decentralized data transmission device and the data transmission network is chosen depending on the marking determined by the packet inspection unit. The operating parameters, i.e. the access parameters of the data transmission connection, are in this case advantageously matched to the particular data transmission application by means of the marking applied to the data packets. In this way, for example, a network customer can chose whether he wants to use a confidential data transmission connection for his data transmission application or prefers to dispense with the confidentiality and use value added services derived from his utilization behavior for more effective processing of his data transmission application.

Advantageously, the data transmission system has an assistance operating mode, a private operating mode and a low-cost operating mode as selectable operating modes. This provides a distinction between three different operating modes, between which the particular network customer can choose, for example using a selection module, e.g. realized as access control software, in the decentralized data transmission device.

In the assistance operating mode, data packet formats detectable by the packet inspection unit are advantageously provided for the transmission of the data packets of a data transmission connection, by means of which data packet formats the data packet contents of a data transmission connection can be determined and correlated with other information obtained from the data transmission network or from the data packet contents of data transmission connections between the data transmission network and/or other decentralized data transmission devices, for the generation of value added services. In contrast to prior art, a correlation of the information obtained from the inspection of the data packet contents with other information sources or data transmission objects on the Internet is performed for the purpose of creating further significant added value from the existing “user” information. In this assistance operating mode, a smart assistance is possible, for example by the provision of databases or search tools tailored to the utilization behavior of the network customer. Furthermore, offerings derived from the data packet contents acquired and correlated and specially tailored to the network customer can be offered to the network customer and appropriate promotional measures can thus be taken that enable the provision of Internet access under more favorable conditions or the creation of additional income for the network operator or service/access provider by means of further smart, chargeable value added services.

The provision in the private operating mode of an encryption of the data packet contents of the data packets of a data transmission connection is also advantageously provided. By using an encryption of the data packet contents in the private operating mode that cannot be decrypted by the service provider in the packet inspection unit, it is possible to establish confidential data transmission connections. It is thus ensured that the network customer can also use confidential connections, for example for financial transactions, in addition to the data transmission connections “monitored” by the packet inspection unit.

The packet inspection unit is advantageously of modular construction and has an inspection module for capturing and categorizing the data packet contents and also a correlation module for correlation of the determined data packet contents in accordance with selectable correlation rules, with delays of less than 100 microseconds by the inspection module during the capture and categorization of data packet contents occurring during the transmission of the inspected data packets. The data packets continue to have the same identical form after inspection by the inspection module. An “inspection unit” of this kind embedded directly in the physical access path between one or more decentralized data transmission devices and the data transmission network enables the acquisition and categorization of the data traffic of a network customer and its correlation with further information sources. In this case, the named inspection module has a performance capacity sufficient for the inspection of all the data packets or Internet packets at “wire speed”, i.e. the bit stream arriving from the inspection module is again output in identical form after a negligibly small time delay. Furthermore, by means of the inspection module in conjunction with the correlation module and using already known technologies (deep packet inspection) and algorithms at least two operating parameters of a data transmission connection per network customer are, for example, reliably distinguished and a correlation between the determined contents, as well of further existing information, is performed. A correlation of this kind can, for example, be used by a service/access provider to provide further appropriate databases to the network customer during the Internet searches carried out by the network customer or, for example, to provide an ongoing or retrospectively authenticating sales offering if the transmission of a pirate copy to the network customer is detected.

Also advantageous is the assignment of a maximum transmission bandwidth by the packet inspection unit in the low-cost operating mode for the transmission of data packets of a data transmission connection.

Further advantageous embodiments of the device in accordance with the invention are given in the dependent claims.

### BRIEF DESCRIPTION OF THE DRAWING

The sole FIGURE shows an embodiment of the invention.

### DETAILED DESCRIPTION OF INVENTION

The invention is explained in more detail in the following by means of an example with reference to the accompanying drawing. The features shown can be essential parts of the invention not only in the named combinations, but also individually or in other combinations.

The illustrated example is a schematic block diagram of a packet-oriented data transmission system PDS configured in accordance with the invention, that has a data transmission network DN and a number of decentralized data transmission devices DE1 to DEn connected via connecting lines or radio interfaces AL with the data transmission network DN. In the example of an embodiment shown, a first decentralized data transmission device DE1 is connected via a connecting line or radio interface AL to a packet inspection unit PIE arranged in the data transmission network DN, said packet inspection until being connected via at least one further connecting line or radio interface AL to second to nth decentralized data transmission devices DE2 to DEn. In this way, several decentralized data transmission devices DE2 to DEn can be connected via one or more separately routed connecting lines or radio interfaces AL to the data transmission network DN or the packet inspection unit PIE.

The packet inspection unit PIE is connected directly in the physical access path between one or more decentralized data transmission devices DE1 to DEn, for example the personal computers of network customers and the data transmission network DN. In this way, the complete data traffic instigated by the particular network customer is forcibly, without the possibility of a bypass for the particular network customer, routed via the packet inspection unit PIE of the data transmission network DN under consideration. Thus, at least theoretically, the possibility is made available to the particular network operator, if required by the network customer, of an almost complete acquisition of the amount of data traffic initiated by a network customer, that after evaluation and correlation with other information can be used to provide value added services or to improve the tariff structure on the basis of “target marketing” campaigns.

A packet labeling unit PLE is provided for each of the first to nth data transmission devices DE1 to DEn, but only the first decentralized data transmission device DE1 has a packet inspection unit PLE of this kind in the example shown in the illustration. In this case, there can also be several packet labeling units PLE in one data transmission device DE1 or one packet labeling unit PLE for a number of data transmission devices DE1 to DEn.

Data packets of at least one data transmission connection are transmitted between one or more decentralized data transmission devices DE1 to DEn and the data transmission network DN. The illustration shows an example of a first data transmission connection dv1, set up to transmit data packets DP between the first decentralized data transmission device DE1 and the data transmission network DN. With the aid of the packet labeling unit PLE, the data packets DP of the first data transmission connection dv1 are marked and transmitted via the connecting line AL to the packet inspection unit PIE provided in the data transmission network DN. In the provided packet inspection unit PIE, the marking applied to the data packets DP of the first data transmission connection dv1 is acquired and, depending on the marking determined by the packet inspection unit PIE, the operating mode of the existing first data transmission connection dv1 between the first decentralized data transmission device DE1 and the data transmission network DN is selected. In this case, marking of the data packets takes place mainly in the upstream transmission direction, i.e. from the decentralized data transmission device DE1 to DEn to the data transmission network DN, with marking being possible both in the upstream and in the downstream directions of transmission. This, however, presumes the provision of a marking module in the packet inspection unit PIE.

For marking the data packets DP, the packet labeling unit PLE, for example, has a low-cost module LB, an assistance module AB and a private module PB, that are connected to a selection module AM. The operating parameters for setting up and operating a data transmission connection in the low-cost operating mode are determined by the low-cost module LB. Similarly, the operating parameters for the setup and operation of a data transmission connection in assistance operating mode and private operating mode are determined by the assistance module AB and private module PB respectively. The choice of three operating modes is given only as an example and can be expanded to as many more operating modes as are required.

With the aid of the selection module AM, it is possible, for example, for the network customer to use the buttons on the user interface of his personal computer to select which of the three available operating modes is to be assigned to a data transmission connection. After the operating mode is selected, at least a part of the data packets DP of the relevant first data transmission connection dv1 is provided by the packet labeling unit PLE with the corresponding marking or label indicating the selected operating mode. The technical realization of the marking of the data packets DP can in this case take place in different ways, not dealt with in greater detail here. The data packets DP, for example marked with a label in this way, of the first data transmission connection dv1 are transmitted via the connecting line AL to the packet inspection unit PIE.

The packet inspection unit PIE is of modular construction, so that the functional scope of the packet inspection unit PIE can be expanded to almost any extent required by adding modules that support further applications. In the example of an embodiment shown, the packet inspection unit PIE has a control device SE, an inspection module IM, a correlation module KM, an encryption/decryption module SM, a blocking module BM and an acquisition module EM, and also a memory unit M connected to the aforementioned modules and the control device SE. These modules of the packet inspection unit PIE can also be individually realized in a mobile or line-connected access transmission system of an access network operator.

Via the control device SE, in the packet inspection unit PIE information obtained through the particular modules is stored in the memory unit M and read from the memory unit M for further processing. The control device SE also controls the individual modules and the exchange of information between the modules.

The inspection module IM is provided particularly for the acquisition and categorization of data packet contents. When doing so, the inspection module IM can not only determine the marking in the data packet header, for example, but also the data packet contents of specified data packet formats and make this data, together with the acquisition time point and the associated network customer identity, available for further processing in the control device SE. The delays caused by the acquisition and categorization of data packet contents by the inspection module IM are in the area of less than 100 microseconds (“wire speed”), i.e. the bit stream received by the inspection module IM is again output in identical form by the inspection module IM after a slight delay. The realization of an inspection module IM of this kind is, for example, based on “deep packet inspection” technology.

The correlation module KM is provided for the correlation of the determined data packet contents in accordance with selectable correlation rules. The information determined by the inspection module IM from the data packet contents is correlated, with the help of the correlation module KM, with other information obtained from the data transmission network DN or from the data packet contents of data transmission connections between the data transmission network DN and/or other decentralized data transmission devices DE1 to DEn. Such a correlation can, for example, be used by a service/access provider to generate value added services that can be offered to the particular network customer in return for a fee. For example, during a search by a network customer a possible chargeable access to further databases is provided or if the inspection module IM detects the transmission of a pirate copy of a piece of music an offer is made to the network customer via an authorized source of supply of pieces of music. The correlation rules can be programmed for individual customers and/or applications in the correlation module KM.

The encryption/decryption module SM is used to encrypt and decrypt both the received and transmitted data packets DP of a data transmission connection, with the keys required for encryption and decryption being present both in the decentralized data transmission device DE1 associated with the data transmission connection and in the packet inspection unit PLE. The decentralized data transmission devices DE1 to DEn also have suitable encryption and decryption modules for this purpose, for example, in the packet labeling unit PLE (not illustrated).

The blocking module BM is used for optional blocking of data transmission connections of at least one operating module, whereby after determination in the inspection module IM of the label/marking applied to the data packets DP, the data packets of a data transmission connection are blocked, or for example, blocked only after the occurrence of other operating parameters, depending on the operating mode indicated by the marking. Furthermore, the blocking module BM has the capability of braking, i.e. forcefully limiting to a given bandwidth, the data packet stream of one or more operating modes.

The acquisition module EM acquires the amount of data in the different operating modes, arranged according to time and the particular network customer.

Furthermore, the packet inspection unit PIE has protective circuit mechanisms that, on the occurrence of faults in the packet inspection unit PIE, switch to a parallel redundant—functionally highly simplified—inspection structure (not illustrated).

If the data packets DP of the first data transmission connection dv1 now have a label indicating the assistance operating mode, this is identified in the packet inspection unit PIE with the aid of the inspection module IM and the operating parameters provided in the assistance operating mode are set for the first data transmission connection dv1 under consideration in the packet inspection unit PIE and also in the packet labeling unit PLE with the aid of the assistance module AB. In the assistance operating mode, the data packets DP of the first data transmission connection dv1 are transmitted exclusively with the aid of data packet formats that can be identified by the packet inspection unit PIE and the network customer thus assents to an identification of the data packet contents with the aid of the inspection module IM. The determined data packet contents of the first data transmission connection dv1 are first categorized with the aid of the inspection module Im and then correlated by the correlation module KM, e.g. depending on category, with other information obtained from the data transmission network DN, or from the data packet contents of data transmission connections between the data transmission network DN and/or other decentralized data transmission devices DE2 to DEn. Value added services tailored to the particular network customer are generated from the information obtained and these are made available to the network customer during the current data transmission session, or during later data transmission connections. This offers the Internet user or network customer intelligent assistance for a variety of purposes in the assistance operating mode via the present usual Internet access basic offering. Further possible services of the Internet provider may also be included for the network customer, guaranteeing confidentiality with respect to third parties and using encryption, inaccessible to third parties, between the decentralized data transmission device DE1 and the data transmission network DN. This is realized, as already described, by the decryption/encryption modules SM provided both in the packet labeling unit PLE and in the packet inspection unit PIE. By means of the assistance operating mode, a service/access provider can advantageously generate additional revenue by the connection of potential transactions and business partners. The possible additional revenue in this case increases with the quality of the correlations provided, which are in turn linked to the performance of the inspection module IM and the correlation module KM and the algorithms and correlation rules implemented thereon. In the assistance operating mode, the provision of a more secure network access including protection against computer viruses and spam control is conceivable as an option by the provision of an antivirus module in addition to an encryption and encryption module SM in the packet inspection unit PIE. In the assistance operating mode, irritating advertising from third-party network operators or service providers can also be suppressed with the aid of the inspection module IM.

In the low-cost operating mode, an assignment of a minimum, minimum transmission bandwidth for the transmission of data packets of the data transmission connection under consideration takes place by means of the blocking module BM arranged in the packet inspection unit PIE. The low-cost operating mode thus represents a more satisfactory variant for a data transmission connection compared to the assistance operating mode. In this case, the network customer accepts all the disadvantages of a data transmission connection that is unprotected and has a limited transmission bandwidth. In the low-cost operating mode, the data packet contents are also acquired and categorized with the aid of the inspection module IM, with the determined information being evaluated predominantly for marketing or sales purposes, that lead to the display of irritating advertising banners during the data transmission sessions. The network operator or service/access provider can achieve additional advertising revenue by a “target marketing” of this kind, that leads to a more satisfactory tariff structure for the network customer.

The private operating mode represents the opposite of this, with an encryption of the data packet contents of the data packets DP of a data transmission connection being permanently provided. The encryption used in the decentralized data transmission device DE1 cannot be decrypted by the decryption/encryption module SM provided in the packet unit PIE because the key is absent. The data packet formats used in the private operating mode can furthermore not be detected by the inspection module IM, so that in the private operating mode the network customer who does not want to swap the unavoidable “Big Brother is watching you” effect of the assistance operating mode for a cost saving during network access can be offered a confidential or protected access from the particular decentralized data transmission device DE1 to DEn on the data transmission network DN.

The operating modes selected, for example using the “buttons” on the user interface of a person computer, with the aid of the selection module AM in the packet labeling unit PLE can be individually billed corresponding to the time units used.

The particular advantage of the different operating modes is that added value can be generated in a way not possible with the present known Internet, independent of the selected operating mode, by providing a flexible Internet access of this kind. If, for example, the telephony sales of a network operator drop due to “peer-to-peer” technologies, these losses can be compensated for by means of a different tariff configuration for the operating modes offered, because “peer-to-peer” telephony can, for example, be suppressed in the assistance operating mode. Furthermore, it is possible to introduce individual operating modes gradually, i.e. first simple forms and then more demanding variants.

A further advantage of the realization of several selectable operating modes with different operating parameters for the particular data transmission connections is the ability to bypass the packet inspection unit PIE arranged in the data transmission network DN when a data transmission connection is being set up by the network customer. The network operator or service/access provider can offer improved value added services based on the more comprehensive information pool and thus an “intelligent assistance” without the network customer having to dispense with confidential data transmission connections.

The selection of an operating mode can in this case be limited to the selection of the private operating mode and/or assistance operating mode, that is preset as standard by the network customer for the “normal” data transmission connections of the low-cost operating mode and can be changed over only by the network customer specifically selecting one of the other possible operating modes. In this way, all combinations of the presetting of a specified operating mode are included.

1.-16. (canceled)

17. A packet-oriented data transmission system, comprising:
a data transmission network; and
a plurality of decentralized data transmission devices connected to the data transmission network, wherein
data packets of at least one data transmission connection being transmitted between one or more of the decentralized data transmission devices and the data transmission network, wherein
in at least one of the decentralized data transmission devices a packet labeling unit for marking the data packets of a data transmission connection is provided, wherein
in the data transmission network at least one packet inspection unit is provided for the acquisition of the marking applied to the data packets of a data transmission connection, and wherein
an operating mode of the data transmission connection existing between the at least one decentralized data transmission device and the data transmission network being selected depending on the marking acquired by the packet inspection unit.

18. The packet-oriented data transmission system in accordance with claim 17, wherein an assistance operating mode, a private operating mode, and a low-cost operating mode are provided as selectable operating modes.

19. The packet-oriented data transmission system in accordance with claim 17, wherein the packet inspection unit is of modular construction.

20. The packet-oriented data transmission system in accordance with claim 19, wherein individual modules of the packet inspection unit are realized in a mobile or line-connected access transmission system of an access network operator.

21. The packet-oriented data transmission system in accordance with claim 19, wherein the packet inspection unit has an inspection module for acquiring and categorizing data packet contents.

22. The packet-oriented data transmission system in accordance with claim 20, wherein the packet inspection unit has an inspection module for acquiring and categorizing data packet contents.

23. The packet-oriented data transmission system in accordance with claim 21, wherein the packet inspection unit has a correlation module for correlation of the acquired data packet contents in accordance with selectable correlation rules.

24. The packet-oriented data transmission system in accordance with claim 22, wherein the packet inspection unit has a correlation module for correlation of the acquired data packet contents in accordance with selectable correlation rules.

25. The packet-oriented data transmission system in accordance with claim 18, wherein data packet formats detectable by the packet inspection unit are provided in the assistance operating mode for the transmission of data packets of a data transmission connection, by means of which data packet formats the data packet contents of a data transmission connection are determined and correlated with other information for the generation of value added services, derived from the data transmission network or the data packet contents of data transmission connections between the data transmission network and/or other decentralized data transmission devices.

26. The packet-oriented data transmission system in accordance with claim 25, wherein an encryption of the data contents of the data packets of a data transmission connection is provided in the assistance operating mode, wherein the encryption and decryption taking place both in the associated decentralized data transmission device and also in an encryption module provided in the packet inspection unit.

27. The packet-oriented data transmission system in accordance with claim 18, wherein in the private operating mode an encryption of the data packet contents of the data packets of a data transmission connection is provided.

28. The packet-oriented data transmission system in accordance with claim 18, wherein in the low-cost operating mode an assignment of a maximum transmission bandwidth for the transmission of the data packets of a data transmission connection is provided by the packet inspection unit.

29. The packet-oriented data transmission system in accordance with claim 17, wherein a selection module for selection of the operating mode of the data transmission connection is provided in the decentralized data transmission device.

30. The packet-oriented data transmission system in accordance with claim 19, wherein delays of less than 100 microseconds arise during the transmission of the inspected data packets, due to the inspection module when acquiring and categorizing data packet contents, wherein the data packets being present in unchanged form after inspection by the inspection module.

31. The packet-oriented data transmission system in accordance with claim 19, wherein the packet inspection unit has an acquisition module for acquiring the amount of data traffic in the different operating modes, arranged according to time and a respective network customer.

32. The packet-oriented data transmission system in accordance with claim 19, wherein the packet inspection unit has a blocking module for the optional blocking of data transmission connections of at least one operating mode.

33. The packet-oriented data transmission system in accordance with claim 19, wherein the packet inspection unit has an antivirus module for the detection and extraction of computer viruses.

34. A method for selecting an operating mode for at least one data transmission connection in a packet-oriented data transmission system, the method comprising:
providing a data transmission connection for the transmission of data packets between one or more decentralized data transmission devices and a data transmission network;
marking the data packets of a data transmission connection in at least one of the decentralized data transmission devices by a packet labeling unit; and
detecting the marking applied to the data packets by a packet inspection unit in the data transmission network, wherein
the operating mode of the data transmission connection existing between the at least one decentralized data transmission device and the data transmission network being selected according to the marking detected by the packet inspection unit.
